(19) United States
(12) Patent Application Publication
(10) Pub. No.: US 2010/0331048 A1
(43) Pub. Date: Dec. 30, 2010

(54) M-S STEREO REPRODUCTION AT A DEVICE

(75) Inventors: Pei Xiang, San Diego, CA (US); Wade L. Heimbigner, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/629,612

(22) Filed: Dec. 2, 2009

Related U.S. Application Data
(60) Provisional application No. 61/220,497, filed on Jun. 25, 2009.
(60) Provisional application No. 61/228,910, filed on Jul. 27, 2009.

(51) Int. Cl. H04B 1/38; H04R 5/00; H04M 1/00

(52) U.S. Cl. 455/557; 381/1; 455/569.1

(57) ABSTRACT

Mid-side (M-S) encoded audio is reproduced by a device that includes a multi-channel digital-to-analog converter (DAC). The DAC has a first channel input receiving a digitized mid audio signal, a first channel output providing an analog mid audio signal, a second channel input receiving a digitized side audio signal and a second channel output providing an analog side audio signal. The DAC may also include a third channel for receiving a digitized second side audio signal. The second side audio signal is phase inverted. The device may be a handheld wireless communication device, such as a cellular phone, and may also include transducers for outputting M-S encoded sound in response to the analog mid and side audio signals.

### CLAIM OF PRIORITY UNDER 35 U.S.C. §119

The present Application for Patent claims priority to Provisional Application No. 61,220,497 entitled “M-S STEREO ACOUSTICS ON MOBILE DEVICES” filed Jun. 25, 2009, and Provisional Application No. 61,228,910 entitled “M-S STEREO ACOUSTICS ON MOBILE DEVICES” filed Jul. 27, 2009, and assigned to the assignee hereof.

### BACKGROUND

1. Field

The present disclosure pertains generally to stereo audio, and more specifically, to mid-side (M-S) stereo reproduction.

2. Background

Stereo sound recording techniques aim to encode the relative position of sound sources into audio recordings, and stereo reproduction techniques aim to reproduce the recorded sound with a sense of those relative positions. A stereo system can involve two or more channels, but two channel systems dominate the field of audio recording. In stereo recording techniques using two microphones, there are many microphone placement techniques. However, in typical two channel systems, the two channels are usually known as left (L) and right (R). The L and R channels convey information relating to the sound field in front of a listener. In particular, the L channel carries information about sound generally located on the left side of the sound field, and the R channel carries information about sound generally located on the right side of the sound field. By far the most popular means for reproducing L and R channel stereo signals is to output the channels via two spaced apart, left and right loudspeakers.

An alternative stereo recording technique is known as mid-side (M-S) stereo. M-S stereo recording has been known since the 1930s. It is different from the more common left-right stereo recording technique. With M-S stereo recording, the microphone placement involves two microphones: a mid microphone, which is a cardioid or figure-8 microphone facing the front of the sound field to capture the center part of the sound field, and a side microphone, which is figure-8 microphone facing sideways, i.e., perpendicular to the axis of the mid microphone, for capturing the sound in the left and right sides of the sound field.

The two recording techniques, L−R and M-S stereo, can each produce a sensation of stereo sound for a listener, when recorded audio is reproduced over a pair of stereo speakers. M-S stereo recordings are typically converted to L−R channels before playback and then broadcast through L−R speakers. M-S stereo channels may be converted to L and R stereo channels using the following equations:

L Channel=Mid+Side Eq. 1

R Channel=Mid−Side Eq. 2

Most commercial two-channel stereo sound recordings are mixed for optimum reproduction by loudspeakers spaced several meters apart. This loudspeaker spacing is not practicable where it is desired to reproduce stereo sound from a small, single unit, such as handheld mobile device.

### SUMMARY

Due to the small size and shape of some devices (e.g., mobile handsets), satisfactory stereo sound is generally difficult to achieve. On these devices, conventional L−R stereo reproduction suffers on loudspeakers typically included in the devices, failing to produce a desirable level of stereo sensation to the listener. Indeed, some devices come with only mono speakerphones, where stereo sound is simply not possible using known device configurations. Thus, there is a need for improved stereo audio reproduction on relatively small devices.

The techniques disclosed herein can make use of handset speakers, which are equipped with every mobile handset, together with speakerphones to create new and improved stereo acoustics on handsets. With devices having mono speakerphones, the sound field of the devices can be enhanced into a more interesting sound experience, other than monophonic sound. In addition, the stereo sound field of devices with stereo speakerphones (i.e., two or more speakerphones) can be expanded acoustically, with little additional computational cost.

According to an aspect, a method of outputting M-S encoded sound at a device includes receiving digitized mid and side audio signals at a digital-to-analog converter (DAC) included in the device. The DAC converts the digitized mid and side audio signals to analog mid and side audio signals, respectively. The mid channel sound is output at a first transducer included in the device, and the side channel sound is output at a second transducer included in the device.

According to another aspect, an apparatus for reproduction of M-S encoded sound includes a multi-channel digital-to-analog converter (DAC). The DAC has a first channel input receiving a digitized mid audio signal, a first channel output providing an analog mid audio signal, a second channel input receiving a digitized side audio signal and a second channel output providing an analog side audio signal.

According to another aspect, an apparatus for reproduction of M-S encoded sound includes a first divide-by-two circuit responsive to a digitized left channel stereo audio signal; a second divide-by-two circuit responsive to a digitized right channel stereo audio signal; a summer to sum digitized left and right channel stereo audio outputs from the first and second divide-by-two circuits; a subtractor to determine the difference between the digitized left and right channel stereo audio outputs from the first and second divide-by-two circuits; a multi-channel digital-to-analog converter (DAC) having a first channel input responsive to digitized sum audio output from the summer and a first channel output providing an analog sum audio signal, and a second channel input responsive to digitized difference audio output from the subtractor and a second channel output providing an analog difference audio signal; a first speaker to produce mid channel sound in response to the analog sum audio signal; and a second speaker to produce side channel sound in response to the analog difference signal.

According to a further aspect, an apparatus includes means for receiving a digitized mid audio signal at a digital-to-analog converter (DAC); means for receiving a digitized side audio signal at the DAC; means for converting a digitized mid audio signal to an analog mid audio signal; means for converting a digitized side audio signal to an analog side audio signal; means for outputting mid channel sound in response to the analog mid audio signal; and means for outputting side channel sound in response to the analog side audio signal.

According to a further aspect, a computer-readable medium, embodying a set of instructions executable by one or more processors, includes code for receiving a digitized mid audio signal at a multi-channel digital-to-analog converter (DAC); code for receiving a digitized side audio signal at the multi-channel DAC; code for converting a digitized mid audio signal to an analog mid audio signal; code for converting a digitized side audio signal to an analog side audio signal; code for outputting mid channel sound in response to the analog mid audio signal; and code for outputting side channel sound in response to the analog side audio signal.

Other aspects, features, and advantages will be or will become apparent to one with skill in the art upon examination of the following figures and detailed description. It is intended that all such additional features, aspects, and advantages be included within this description and be protected by the accompanying claims.

### BRIEF DESCRIPTION OF THE DRAWINGS

It is to be understood that the drawings are solely for purpose of illustration. Furthermore, the components in the figures are not necessarily to scale, emphasis instead being placed upon illustrating the principles of the techniques described herein. In the figures, like reference numerals designate corresponding parts throughout the different views.

FIG. 1 is a diagram of an exemplary device for reproducing M-S encoded sound using a pair of speakers.

FIG. 2 is a diagram of an exemplary device for reproducing M-S encoded sound using three speakers.

FIG. 3 is a diagram illustrating an exemplary mobile device for reproducing M-S encoded sound using two speakers.

FIG. 4 is a diagram illustrating an exemplary mobile device for reproducing M-S encoded sound using three speakers.

FIG. 5 is a diagram illustrating certain details of an exemplary audio circuit includable in the devices of FIGS. 1 and 3.

FIG. 6 is a schematic diagram illustrating certain details of the audio circuit of FIG. 5.

FIG. 7 is a diagram illustrating details of exemplary digital processing performed by the audio circuit of FIGS. 5-6.

FIG. 8 is a schematic diagram illustrating certain details of an alternative audio circuit that is includable in the devices of FIGS. 1 and 3.

FIG. 9 is a schematic diagram illustrating certain details of another alternative audio circuit that is includable in the devices of FIGS. 1 and 4.

FIG. 10 is a diagram illustrating details of differential drive audio amplifiers and speakers that can be used in the audio circuit of FIG. 9.

FIG. 11 is a diagram illustrating details of a differential DAC, differential audio amplifiers and speakers that can be used in the audio circuit of FIG. 9.

FIG. 12 is a diagram illustrating certain details of an exemplary audio circuit includable in the devices of FIGS. 2 and 4.

FIG. 13 is a schematic diagram illustrating certain details of the audio circuit of FIG. 12.

FIG. 14 is a schematic diagram illustrating certain details of an alternative audio circuit that is includable in the devices of FIGS. 2 and 4.

FIG. 15 is a diagram illustrating details of differential drive audio amplifiers and speakers that can be used in the audio circuits of FIGS. 12-14.

FIG. 16 is a diagram illustrating details of a differential DAC, differential audio amplifiers and speakers that can be used in the audio circuits of FIGS. 12-14.

FIG. 17 is an architecture that can be used to implement any of the audio circuits described in connection with FIGS. 1-16.

FIG. 18 is a flowchart illustrating a method of reproducing M-S encoded sound at a device.

FIG. 19 is a diagram illustrating a mobile device reproducing M-S encoded sound on a separate accessory device connected over a wired link.

FIG. 20 is a diagram illustrating a mobile device reproducing differentially encoded M-S encoded sound on a separate accessory device connected over a wired link.

FIG. 21 is a diagram illustrating a mobile device outputting M, S+, S− signals to reproduce M-S encoded sound on a separate accessory device connected over a wired link.

FIG. 22 is a diagram illustrating a mobile device outputting M, S+, S− signals to reproduce differential M-S encoded sound on a separate accessory device connected over a wired link.

FIG. 23 is a diagram illustrating a mobile device outputting M, S+, S− signals on an analog wireless link to reproduce M-S encoded sound on a separate accessory device.

FIG. 23A is a diagram illustrating a mobile device outputting only M, S+ signals on an analog wireless link to reproduce M-S encoded sound on a separate accessory device.

FIG. 24 is a diagram illustrating a mobile device outputting M, S+, S− signals on a digital wireless link to reproduce M-S encoded sound on a separate accessory.

FIG. 25 is a diagram illustrating a mobile device outputting only M, S+ signals on a wireless link to reproduce M-S encoded sound on a separate accessory.

FIGS. 26 and 26A are diagrams illustrating mobile devices outputting M-S signals to reproduce M-S encoded sound on a separate accessory device connected to the mobile device with a digital wired link.

### DETAILED DESCRIPTION

The following detailed description, which references to and incorporates the drawings, describes and illustrates one or more specific embodiments. These embodiments, offered not to limit but only to exemplify and teach, are shown and described in sufficient detail to enable those skilled in the art to practice what is claimed. Thus, for the sake of brevity, the description may omit certain information known to those of skill in the art.

The word “exemplary” is used throughout this disclosure to mean “serving as an example, instance, or illustration.” Anything described herein as “exemplary” is not necessarily to be construed as preferred or advantageous over other approaches or features.

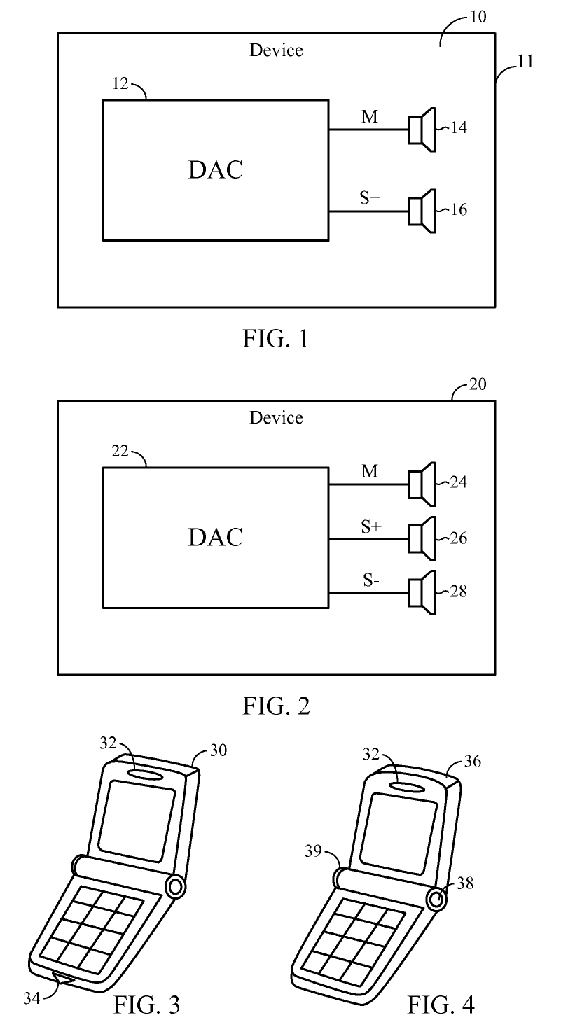

FIG. 1 is a diagram of an exemplary device 10 for reproducing M-S encoded sound using a pair of audio transducers, e.g., speakers 14, 16. The device 10 includes a digital-to-analog converter (DAC) 12. The first speaker 14 outputs a mid (M) channel and the second speaker 16 outputs one of the side (S+) channels. The device 10 produces a compelling stereo sound field that a pair of similarly sized stereo speakers can produce, with all of the audio transducers (speakers 14, 16) housed in a single enclosure 11.

The device 10 may be any electronic device suitable for reproducing sound, such as a speaker enclosure, stereo system component, laptop computer, gaming console, handheld device, such as a cellular phone, personal digital assistant (PDA), gaming device or the like.

The DAC 12 can be any suitable multi-channel DAC having a first channel input receiving a digitized mid (M) audio signal and a first channel output providing an analog M audio signal in response to the digitized M audio signal. The DAC 12 can also include a second channel input receiving a digitized side (S+) audio signal and a second channel output providing an analog S+ audio signal in response to the digitized S+ audio signal. The DAC may be included in an integrated communications system on a chip, such as Mobile Station Modem (MSM) chip.

Typical mobile devices, such as mobile cellular handsets, have small enclosures, where two speakers cannot be too far away apart, due to the size limitations. These devices are suitable for the M-S stereo reproduction techniques disclosed herein. Most commercially-available mobile handsets support both handset mode (to make a phone call) and speakerphone mode (hands-free phone call or listening to music in open air), thus these two types of speakers are already installed on many handsets. The handset speaker is usually mono, because one channel is enough for voice communication. The speakerphone speaker(s) can be either mono or stereo.

An example of a cellular phone 30 having a handset speaker 32 and a single mono speakerphone speaker 34 for reproducing M-S encoded sound is shown in FIG. 3. As is typical of some cellular phones, the handset speaker 32 is located at the center-front of the device 30 for placing next to the user's ear, and thus, can be used for the mid channel output. In most phones, speakerphone speakers are either front-firing (located on the front of the phone), side-firing (located on the side of the phone), or located in the back. In the example of FIG. 3, the speakerphone speaker 34 is located near the back of the phone 30. Even though the speakerphone 34 is mono, one side channel (e.g., S+) can be reproduced at the mono speaker 34. If the location of speakerphone speaker 34 is relatively farther away from the handset speaker 32, more interesting acoustics can be reproduced.

In conventional cellular handsets, the handset speaker and speakerphone speakers are never used simultaneously, and thus, conventional handsets are not configured to simultaneously output sound on both handset and speakerphone speakers. The main reason that the speakers are never used together is that a conventional handset usually has only one stereo digital-to-analog converter (DAC) to drive either (pair of) speaker(s), and additional DAC is needed to drive all of the speakers simultaneously. Adding an additional DAC means significantly increased production cost. With the modifications disclosed herein, it is possible to reproduce M-S encoded stereo on a handset with an existing stereo DAC. The audio outputs to the handset and speakerphone speakers are coordinated so that the whole device is available to reproduce M-S encoded stereo, achieving a better sound field than just using existing speakerphone speakers.

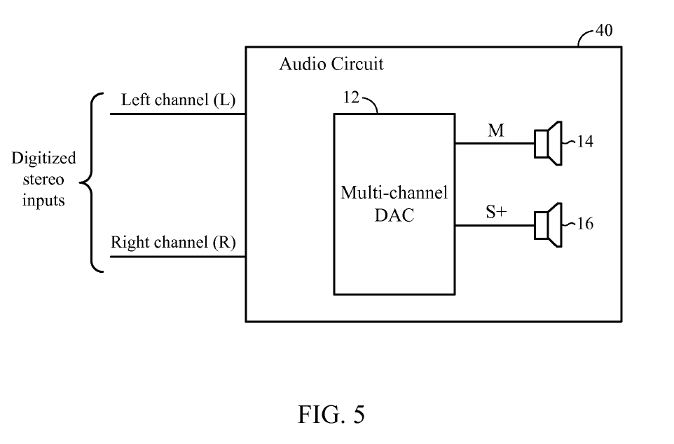

If the speakerphone speaker within the mobile device is mono (i.e., only one speakerphone speaker is included in the device), the circuit signal routing in this example can be implemented as what is shown in FIGS. 5, 6 and 8, further described herein below. In this case, side channel is directly used to drive the mono speakerphone speaker 34, and mid channel is driving the handset speaker 32. Acoustically, the sound field reproduced this way is not true M-S stereo, but since the handset speaker 32 is located in the front facing the user, and the mono speakerphone 34 is most likely on the back of the device 30, the combined acoustics is an improvement of the mono speakerphone case. With two speakers, and some good stereo source materials, the two speaker 32, 34 working together significantly diversify the spatial sound patterns, distributing the common (sum or mid) signal of the stereo field from the front handset speaker 32 and a difference (side channel) signal from another speaker 34 with a different location in the device enclosure. The resulting sound field will be considerably more stereo-like than devices with only one mono speaker.

Returning now to FIG. 2, this figure is a diagram of an exemplary device 20 for reproducing M-S encoded sound using three audio transducers, e.g., speakers 24, 26, 28. The device 20 includes a DAC 22. The first speaker 24 outputs a mid (M) channel, the second speaker 26 outputs one of the side (S+) channels, and the third speaker 28 outputs the other side channel (S−). The S+ and S− audio channels are phase inverted by approximately 180 degrees. The speakers 26 and 28 can be used to produce the phase-negated side channel(s).

The device 20 may be any electronic device suitable for reproducing sound, such as a speaker enclosure, stereo system component, laptop computer, gaming console, handheld device, such as a cellular phone, personal digital assistant (PDA), gaming device or the like.

The DAC 22 can be any suitable multi-channel DAC having a first channel input receiving a digitized mid (M) audio signal and a first channel output providing an analog M audio signal in response to the digitized M audio signal. The DAC 22 also includes a second channel input receiving a digitized side (S+) audio signal and a second channel output providing an analog S+ audio signal in response to the digitized S+ audio signal. The DAC 22 further includes a third channel input receiving a digitized side (S−) audio signal and a third channel output providing an analog S− audio signal in response to the digitized S− audio signal. The DAC may be included in an integrated communications system on a chip, such as Mobile Station Modem (MSM) chip.

FIG. 4 is a diagram illustrating an exemplary cellular phone 36 for reproducing M-S encoded sound using three speakers 32, 38, 39. The handset speaker 32 is located on the front center of the phone 36, and the speakerphone speakers 38, 39 are side-firing speakers for outputting stereo audio. When the phone 36 is configured to output M-S encoded stereo, the handset speaker 32 outputs the M channel, and the speakerphone speakers 38, 39 are used to produce phase-negated side channel(s), S+ and S−.

The benefits of M-S stereo acoustics on mobile handsets, as disclosed herein, can be summarized as follows: mobile devices can accept conventional L−R stereo audio recording, the added computation load of the M-S audio on the devices processor is minimal, and the M-S techniques more fully utilize existing mobile handset hardware assets (speakers), and the output M-S stereo sound field is tunable (for the width and coherence in the center) by balancing gains between mid and side channels. For typical speaker configurations as shown in FIGS. 3-4, stereo expansion can be readily achieved, and the size of effective sound field can be increased. This enhances mono speakerphone devices, such as the one illustrated in FIG. 3, to have more enjoyable acoustics when playing stereo sound files.

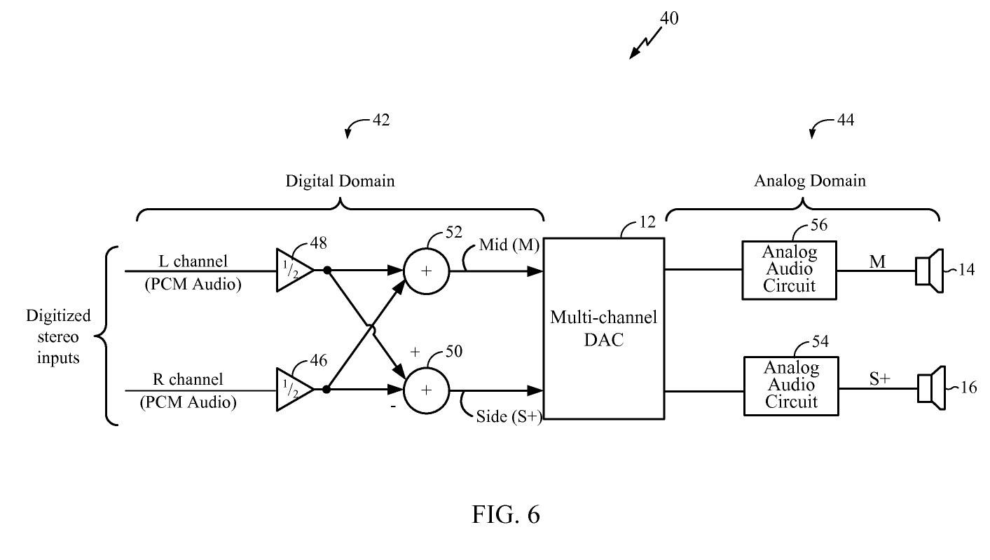

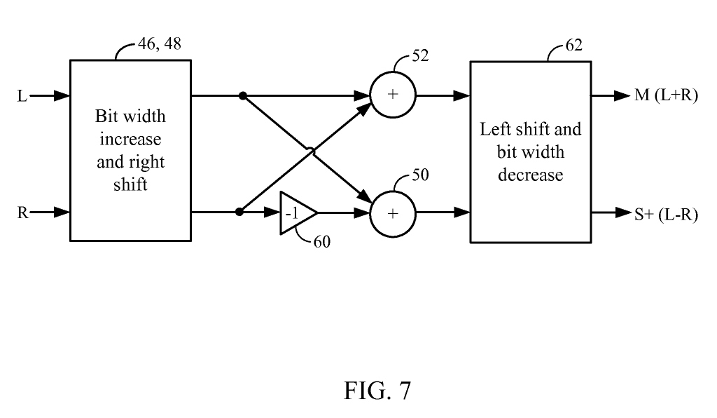

FIG. 5 is a diagram illustrating certain details of an exemplary audio circuit 40, includable in the devices 10, 30 of FIGS. 1 and 3, for reproducing M-S stereo audio from conventional digitized L−R stereo encoded sources, such as MP3, WAV or other audio files or streaming audio inputs. The audio circuit 40 includes the multi-channel DAC 12 and speaker 14, 16, as well as other circuits for processing the audio channels, as described in further detail below in connection with FIGS. 6 and 7. The audio circuit 40 receives digitized stereo L and R audio channel inputs, and in response to the inputs, converts the L−R audio to M-S encoded audio, and outputs two of the M-S stereo channels: the M channel on the mid speaker 14, and either the S+ channel (as shown in the example) or the S− channel on the side speaker 16.

The audio circuit 40 may convert the L and R stereo channels to corresponding M-S channels according to the following relationships:

M=(L+R)/2 Eq. 3

S+=(L−R)/2 Eq. 4

S−=(R−L)/2 Eq. 5

In Equations 3-5, M represents the mid channel audio signal, L represents the left channel audio signal, R represents the right channel audio signal, S− represents the phase inverted side channel audio signal, and S+ represents the non-inverted side channel audio signal. Other variations of Equations 3-5 may be employed by the audio circuit 40 to convert L−R stereo to M-S stereo.

FIG. 6 is a schematic diagram illustrating certain details of the audio circuit 40 of FIG. 5. In the signal path before the DAC 12 (e.g., digital audio post-processing), L−R (left-right) stereo signals are translated into M-S stereo with the circuit components shown in FIG. 6.

The audio circuit 40 includes the DAC 12 in communication with digital domain circuitry 42 and analog domain circuitry 44. Most stereo media is record in L−R stereo format. The digital domain circuitry 42 receives pulse code modulated (PCM) audio of the L and R audio channels. Dividers 46, 48 divide the PCM audio samples of R and L channels, respectively, by 2. The output of the L channel divider 48 is provided to adders 50, 52. The output of the R channel divider 46 is provided to adder 52, and also inverted, and then provided to adder 50.

The output of adder 52 provides the M channel audio samples to a first channel of the DAC 12, and the output of adder 50 provides the S+ channel audio samples to a second channel of the DAC 12.

The DAC 12 converts the M channel samples to the M analog audio channel signal, and converts the S+ channel sample to the S+ analog audio channel signal. The M analog audio channel signal may be further processed by an analog audio circuit 56 and the S+ analog audio channel signal may be further processed by an analog audio circuit 54. The audio output signals of the analog audio circuits 54, 56 are then provided to the speakers 16, 14, respectively, where they are reproduced so that they may be heard by the user.

The analog audio circuits 54, 56 may perform audio processing functions, such as filtering, amplification and the like on the analog M and S+ channel analog signals. Although shown as separate circuits, the analog audio circuits 54, 56 may be combined into a single circuit.

Using the circuit 40 to realize M-S stereo on mobile handsets, modifications may have to be made in the signal paths and/or hardware audio routing. The inputs and outputs of the DAC are reconfigured to receive and output M-S signals, as shown in FIG. 6, instead of L−R signals. In handsets having only a handset and one speakerphone speaker (e.g., phone 30 of FIG. 3), the M channel output is used to drive the handset speaker (e.g., speaker 32), and the S+ channel output is used to drive the speakerphone speaker (e.g., speaker 34).

The circuit 40 may also be employed in handsets having a handset and two speakerphone speakers (e.g., phone 36 of FIG. 4). In this case, the M channel signal is used to drive the handset speaker (e.g., 32), which is usually located at the front center portion of the mobile device. The S+ channel is used on one path to drive one or both of the stereo speakerphone speakers (e.g., either speaker 38 or 39), preferably a side-firing speaker.

FIG. 7 is a diagram illustrating further details of exemplary digital processing performed by the digital domain 42 of the audio circuit 40 of FIGS. 5-6. The dividers 46, 48 increase the bit width of L and R channel input signals, and arithmetically shift these digital signals one bit to the right to prevent overflow when added by the adders 50, 52. A 1's-complement inverter 60 causes the negative value of the R channel signal to be provided to the adder 50. After summations by the adders 50, 52, each of the adder outputs is left-shifted by one bit and the bit width is decreased to the original bit width (block 62).

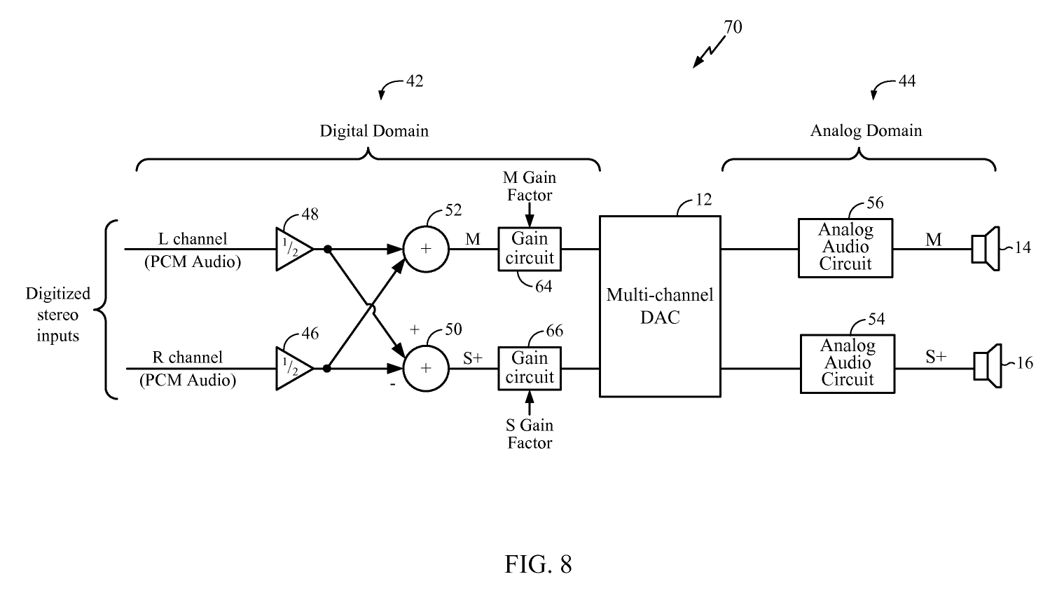

FIG. 8 is a schematic diagram illustrating certain details of an alternative audio circuit 70 that is includable in the devices 10, 30 of FIGS. 1 and 3. The audio circuit 70 includes means for selectively adjusting the gains in the M and S+ digital audio channels so that the output M-S stereo sound field is tunable (for the width and coherence in the center) by adjusting the gains between M and S channels. As shown in FIG. 8, the means may include an M channel gain circuit 64 and an S+ channel gain circuit 66. The M channel gain circuit 64 applies an M channel gain factor to the digital M channel audio signal before it is converted by the DAC 12, and the S+ channel gain circuit 66 applies an S+ channel gain factor to the digital S channel audio signal before it is converted by the DAC 12. Each of the gain circuits 64, 66 may implement a multiplier for multiplying the respective M-S audio signal by a respective gain factor value. The gain factor values may be stored in a memory and tuned to adjust the M-S sound field reproduced by a particular device. The gain values can be determined for a device empirically and pre-loaded into the memory during manufacture. Alternatively, a user interface may be included in a device that allows a user to adjust the stored gain factor values to tune the output sound field.

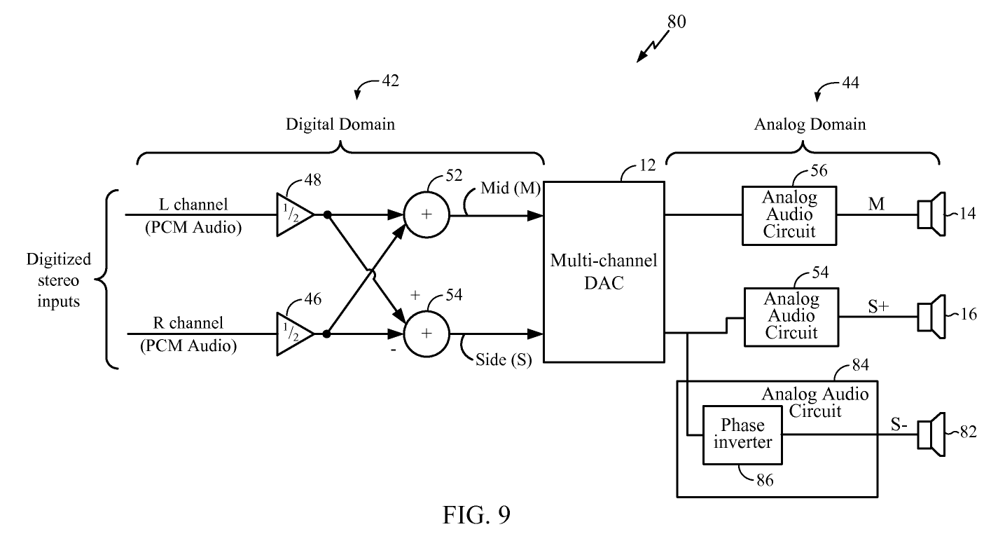

FIG. 9 is a schematic diagram illustrating certain details of another alternative audio circuit 80 that is includable in the devices of FIGS. 1 and 4. The audio circuit 80 includes a third analog audio circuit 84, which includes a phase inverter 86. The analog circuit 84 receives the S+ analog audio channel output from the DAC 12, and output an inverted side channel (S−) to a third audio transducer, e.g., a speaker 82. The analog audio circuit 84 can perform audio processing functions, such as filtering, amplification and the like. In addition, the phase inverter 86 inverts the S+ analog signal to produce the S− analog signal. The phase inverter 86 can be an inverting amplifier.

Although shown as separate circuits, the analog circuits 54, 56, 84 can be combined into a single analog circuit.

The circuit 80 may be employed in handsets having a handset and two speakerphone speakers (e.g., phone 36 of FIG. 4). In this case, the M channel signal is used to drive the handset speaker (e.g., 32), which is usually located at the front center portion of the mobile device. The S+ channel is used on one path to drive one of the stereo speakerphone speakers (e.g., either speaker 38 or 39), preferably a side-firing speaker. The S− channel is used to drive the other speakerphone speaker.

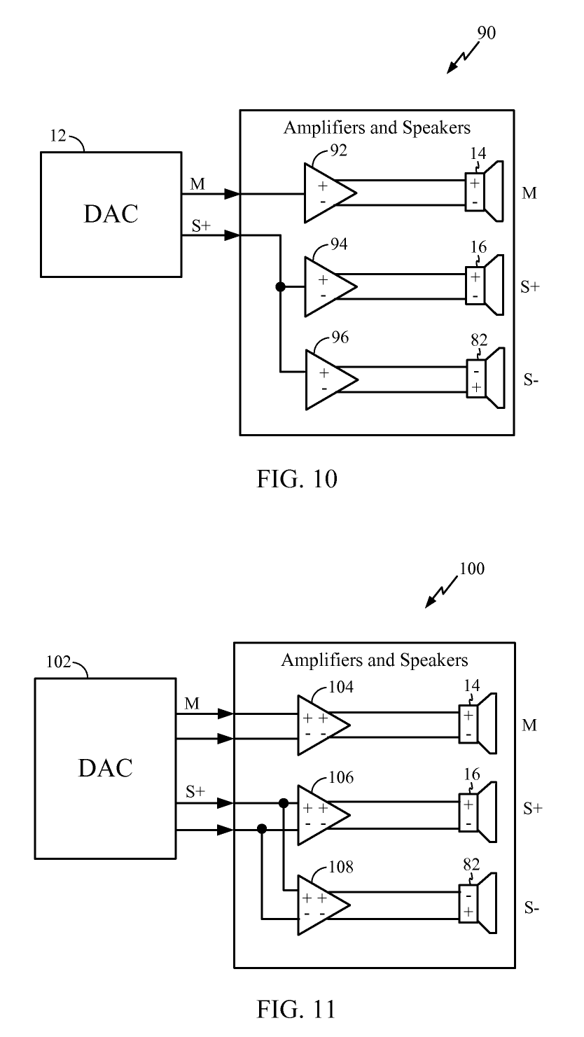

FIG. 10 is a diagram illustrating a circuit 90 having differential drive audio amplifiers 92, 94, 96 and speakers 14, 16, 82 that can be used in the audio circuit 80 of FIG. 9. The M-channel differential amplifier 92 receives a non-differential M channel audio signal from the DAC 12, and in turn, outputs a differential M channel analog audio signal to drive the differential speaker 14 to reproduce the M channel sounds. The S+ channel differential amplifier 94 receives a non-differential S+ channel audio signal from the DAC 12, and in turn, outputs a differential S+ channel analog audio signal to drive the differential speaker 16 to reproduce the S+ channel sounds. The S-channel differential amplifier 96 receives the non-differential S+ channel audio signal from the DAC 12, and in turn, outputs a differential S− channel analog audio signal to drive the differential speaker 82 to reproduce the S− channel sounds. The polarity of the speaker 82 inputs is reversed relative to the outputs of the S− channel differential amplifier to effectively invert the S+ channel signal, whereby creating the S− channel audio.

FIG. 11 is a diagram illustrating a circuit 100 having a differential DAC 102, differential audio amplifiers 104, 106, 108 and speakers 14, 16, 82 that can alternatively be used in the audio circuit 80 of FIG. 9. The DAC 102 performs the functions of DAC 12, but also outputs differential M and S+ channel analog outputs. These differential M and S+ outputs drive the differential amplifiers 104-108. The outputs of the differential amplifiers 104-108 are connected to the speakers 14, 16, 82 in the same manner as the speakers 14, 16, 82 of FIG. 10.

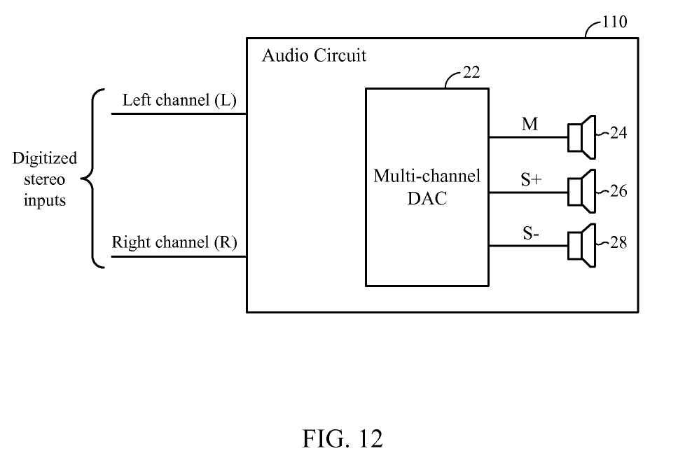

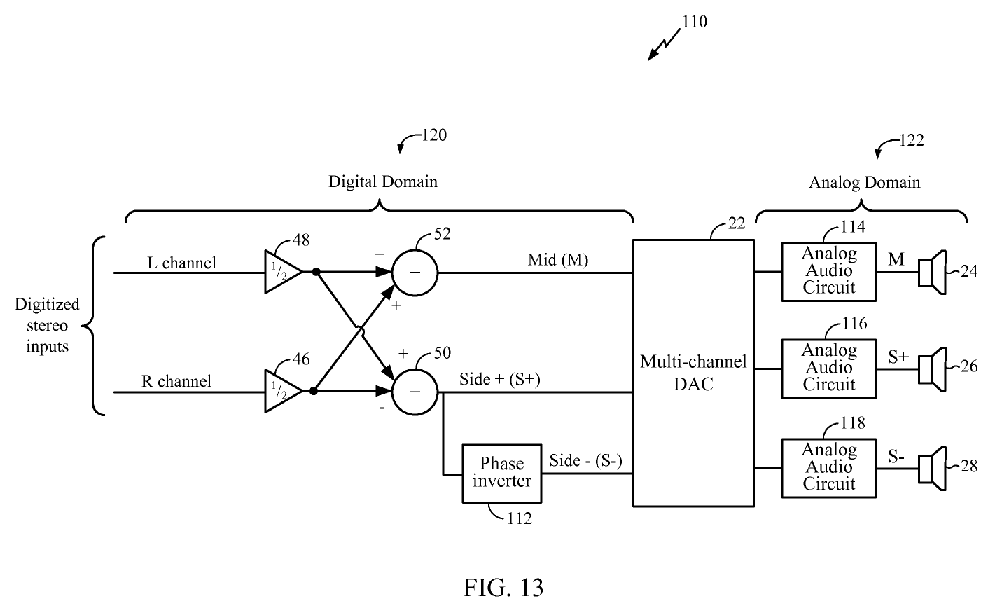

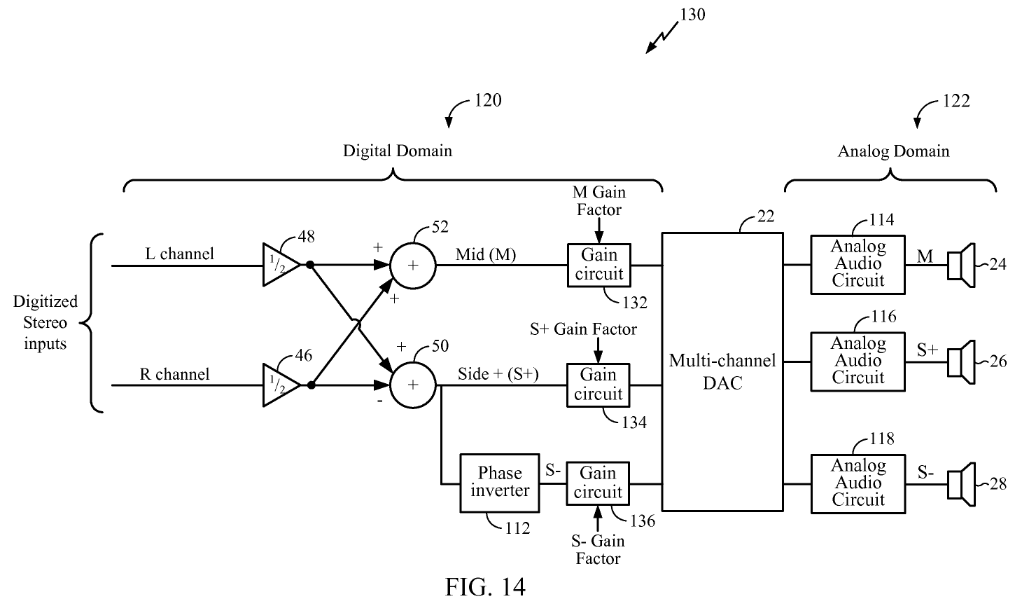

FIG. 12 is a diagram illustrating certain details of an exemplary audio circuit 110, includable in the devices 20, 36 of FIGS. 2 and 4, for reproducing M-S stereo audio from conventional digitized L−R stereo encoded sources, such as MP3, WAV or other audio files or streaming audio inputs. The audio circuit 110 includes the multi-channel DAC 22 and speakers 24, 26, 28, as well as other circuits for processing the audio channels, as described in further detail below in connection with FIGS. 13 and 14. The audio circuit 110 receives digitized stereo L and R audio channel inputs, and in response to the inputs, converts the L−R audio to M-S encoded audio, and outputs the three M-S stereo channels: the M channel on the mid speaker 24, and either the S+channel on S+ channel speaker 26, and the S− channel on the S− channel speaker 28. The conversion of the L−R channels to M-S channels can be performed according to Equations 3-5.

FIG. 13 is a schematic diagram illustrating certain details of the audio circuit 110 of FIG. 12. In the signal path before the DAC 22 (e.g., digital audio post-processing), L−R (left-right) stereo signals are translated into M-S stereo with the circuit components shown in FIG. 6. The audio circuit 110 includes the DAC 22 in communication with digital domain circuitry 120 and analog domain circuitry 122. Most stereo media is record in L−R stereo format. The digital domain circuitry 120 receives pulse code modulated (PCM) audio of the L and R audio channels.

The digital audio signals processed by the dividers 46, 48 and adders 50, 52 can be bit shifted, increased in width, and then decreased in width, as discussed above in connection with FIG. 7.

In addition to the components shown in FIG. 6, the digital domain circuitry 120 of FIG. 13 includes a phase inverter 112, the inverts the S+ signal output from adder 50 by 180 degrees to produce the S− digital audio channel. The phase inverter 112 may include a 1's-complement circuit to invert the S+ signal.

The DAC 22 converts the M channel samples to the M analog audio channel signal, the S+ channel samples to the S+ analog audio channel signal, and the S-channel samples to the S− analog audio channel signal. The M analog audio channel signal may be further processed by an analog audio circuit 114; the S+ analog audio channel signal may be further processed by an analog audio circuit 116; and the S-analog audio channel signal may be further processed by an analog audio circuit 118. The audio output signals of the analog audio circuits 114, 116, 118 are then provided to the speakers 42, 26, 28, respectively, where they are reproduced so that they may be heard by the user.

The analog audio circuits 114, 116, 118 may perform audio processing functions, such as filtering, amplification and the like on the analog M, S+ and S− channel analog signals, respectively. Although shown as separate circuits, the analog audio circuits 114-118 may be combined into a single circuit.

Using the circuit 110 to realize M-S stereo on mobile handsets, modifications may have to be made in the signal paths and/or hardware audio routing. The inputs and outputs of the DAC 22 are reconfigured to receive and output M-S signals, as shown in FIG. 13, instead of L−R signals. The circuit 110 may be employed in handsets having a handset and two speakerphone speakers (e.g., phone 36 of FIG. 4). In this case, the M channel signal is used to drive the handset speaker (e.g., 32), which is usually located at the front center portion of the mobile device. The S+ channel is used to drive one of the stereo speakerphone speakers (e.g., either speaker 38 or 39), preferably a side-firing speaker, and the S− channel is used to drive the other speakerphone speaker. In this way, the stereo speakerphone speakers are used to reproduce side-direction sound field, perpendicular to the front-back direction.

FIG. 14 is a schematic diagram illustrating certain details of an alternative audio circuit 130 that is includable in the devices 20, 36 of FIGS. 2 and 4. The audio circuit 130 includes means for selectively adjusting the gains in the M and S digital audio channels so that the output M-S stereo sound field is tunable (for the width and coherence in the center) by adjusting the gains between M and S channels. As shown in FIG. 14, the means may include an M channel gain circuit 132, an S+ channel gain circuit 134, and an S− channel gain circuit 136. The M channel gain circuit 312 applies an M channel gain factor to the digital M channel audio signal before it is converted by the DAC 22, the S+ channel gain circuit 134 applies an S+ channel gain factor to the digital S+ channel audio signal before it is converted by the DAC 22, and the S− channel gain circuit 136 applies an S− channel gain factor to the digital S− channel audio signal before it is converted by the DAC 22. Each of the gain circuits 132, 134, 136 may implement a multiplier for multiplying the respective M-S audio signal by a respective gain factor value. The gain factor values may be stored in a memory and tuned to adjust the M-S sound field reproduced by a particular device. The gain values can be determined for a device empirically and pre-loaded into the memory during manufacture. Alternatively, a user interface may be included in a device that allows a user to adjust the stored gain factor values to tune the output sound field.

In addition, various stereo enhancement techniques can be applied to the (S+, S−) side channel pair of signals to further enhance the quality of the phase-inverted side channels.

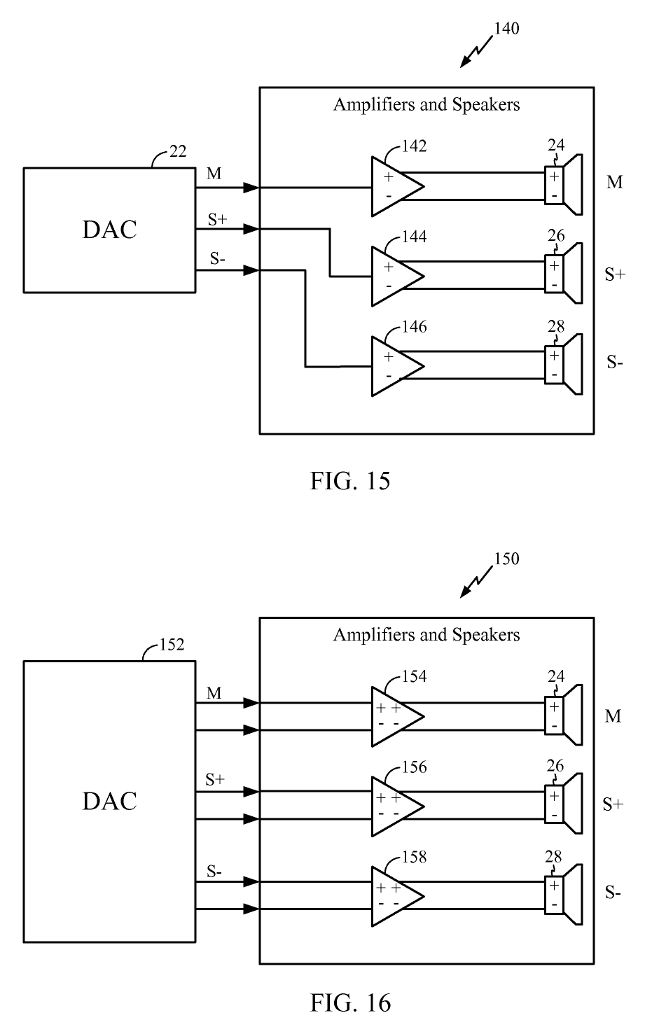

FIG. 15 is a diagram illustrating a circuit 140 having differential drive audio amplifiers 142, 144, 146 and speakers 24, 26, 28 that can be used in the audio circuits 110, 130 of FIGS. 13-14. The M-channel differential amplifier 142 receives a non-differential M channel audio signal from the DAC 22, and in turn, outputs a differential M channel analog audio signal to drive the differential speaker 24 to reproduce the M channel sounds. The S+ channel differential amplifier 144 receives a non-differential S+ channel audio signal from the DAC 22, and in turn, outputs a differential S+ channel analog audio signal to drive the differential speaker 26 to reproduce the S+ channel sounds. The S− channel differential amplifier 146 receives the non-differential S-channel audio signal from the DAC 22, and in turn, outputs a differential S− channel analog audio signal to drive the differential speaker 28 to reproduce the S− channel sounds.

FIG. 16 is a diagram illustrating a circuit 150 having a differential DAC 152, differential audio amplifiers 142, 144, 146 and speakers 24, 26, 28 that can alternatively be used in the audio circuits 110, 130 of FIGS. 13 and 14. The DAC 152 performs the functions of DAC 22, but also outputs differential M, S+, and S− channel analog outputs. These differential M, S+ and S− outputs drive the differential amplifiers 154-158. The outputs of the differential amplifiers 154-158 are connected to the speakers 24, 26, 28 in the same manner as the speakers 24, 26, 28 of FIG. 15.

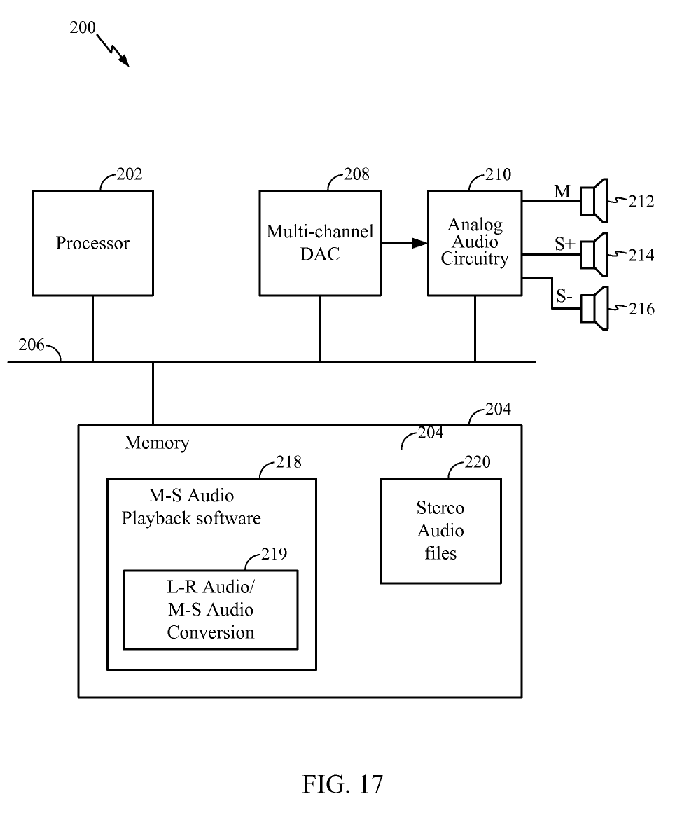

FIG. 17 is an architecture 200 that can be used to implement any of the audio circuits 40, 70, 80, 110, 130 described in connection with FIGS. 1-16. The architecture 200 includes one or more processors (e.g., processor 202), coupled to a memory 204, a multi-channel DAC 208 and analog circuitry 210 by way of a digital bus 206. The architecture 200 also includes M, S+ and S− channel audio transducers, such as speakers 212, 214, 216.

The analog audio circuitry 210 includes analog circuitry to additionally process the M-S analog audio signals that are being output to the speakers 212-216. Filtering, amplification, phase inversion of the side channel, and other audio processing functions can be performed by the analog audio circuitry 210.

The processor 202 executes software or firmware that is stored in the memory 204 to provide any of the digital domain processing described in connection with FIGS. 1-16. The processor 202 can be any suitable processor or controller, such as an ARM7, digital signal processor (DSP), one or more application specific integrated circuits (ASICs), field programmable gate arrays (FPGAs), complex programmable logic devices (CPLDs), discrete logic, or any suitable combination thereof. Alternatively, the processor 202 may be implemented as a multi-processor architecture having a plurality of processors, such as a microprocessor-DSP combination. In an exemplary multi-processor architecture, a DSP can be programmed to provide at least some of the audio processing and conversions disclosed herein and a microprocessor can be programmed to control overall operating of the device.

The memory 204 may be any suitable memory device for storing programming code and/or data contents, such as a flash memory, RAM, ROM, PROM or the like, or any suitable combination of the foregoing types of memories. Separate memory devices can also be included in the architecture 200. The memory stores M-S audio playback software 218, which includes L−R audio/M-S audio conversion software 219. The memory 218 may also store audio source files, such as PCM, .wav or MP3 files for playback using the M-S audio playback software 218. In addition, the memory 218 may also store gain factor values for the gain circuits 64, 66, 132, 134, 136 described above in connection with FIGS. 8 and 14.

When executed by the processor 202, the M-S audio playback software 218 causes the device to reproduce M-S encoded stereo in response to input L−R stereo audio, as disclosed herein. The playback software 218 may also re-route audio processing paths and re-configure resources in a device so that M-S encoded stereo is output by handset and speakerphone speakers, as described herein, in response to input L−R encoded stereo signals. The audio L−R audio/M-S audio conversion software 219 converts digitized L−R audio signals into M-S signals, according to Equations 3-5.

The components of the architecture 200 may be integrated onto a single chip, or they may be separate components or any suitable combination of integrated and discrete components. In addition, other processor-memory architectures may alternatively be used, such as multi-memory arrangements.

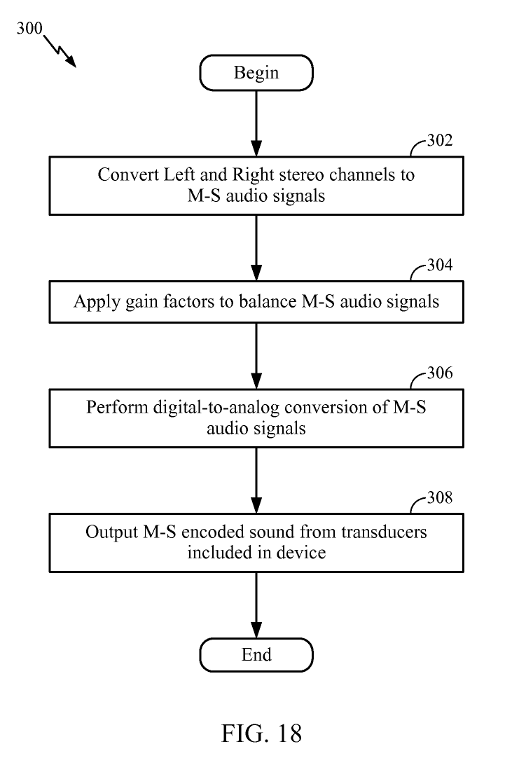

FIG. 18 is a flowchart 300 illustrating a method of reproducing M-S encoded sound at a device. In block 302 L and R stereo channels are converted to M-S audio signals. The conversion can be performed according to Equations 3-5 using the circuits and/or software described herein.

In block 304, gain factors are optionally applied to balance the M-S audio signals, as described above in connection with either of FIG. 8 or 14.

In block 306, a digital to analog conversion is performed on the digital M-S audio signals to produce analog M-S stereo signals, as described in connection with FIGS. 1 and 2.

In block 308, audio transducers, such as speakers, are driven by the analog M-S stereo signals to reproduce the M-S encoded signal at the device. Either two or three of the M-S channels can be reproduced by the device, as described herein.

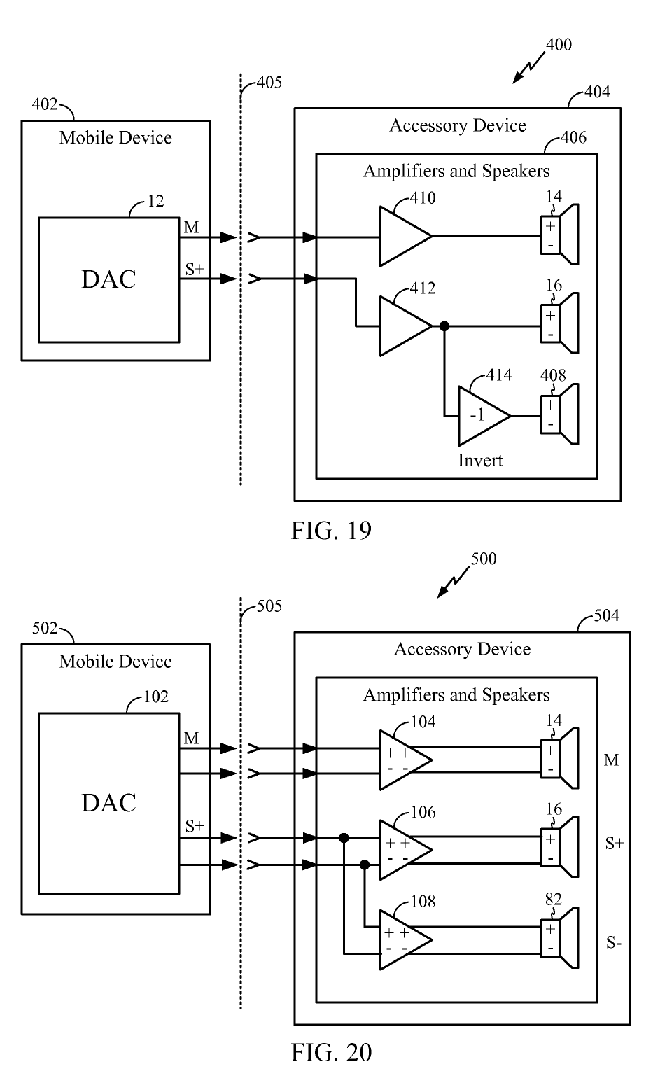

FIG. 19 is a diagram illustrating system 400 including a mobile device 402 reproducing M-S encoded sound on a separate accessory device 404 connected over a wired link 405. The mobile device 402 includes the DAC 12, and can be any suitable mobile device for reproducing sound, such as a computer, gaming device, radio, cellular phone, personal digital assistant (PDA), or the like. The mobile device 402 is configured to include the digital domain audio processing and the DAC 12, as described above in connection with FIGS. 5, 6, 8 and 9, for producing M-S encoded analog audio signals.

The accessory device 404 can be any suitable electronic device that is not part of the mobile device's enclosure. For example, the accessory device 404 can be a headset or a separate speaker enclosure. Essentially, the accessory device 404 includes the analog audio processing circuitry for reproducing the M-S channels. The accessory device 404 receives the M channel and S+ channel analog audio outputs from the DAC 12 by way of the wired link 405. The accessory device 404 includes an M channel audio amplifier 410 for driving an M channel speaker 14, a S+ channel audio amplifier 412 for driving an S+ channel speaker 16, and an inverting audio amplifier 414, responsive to the output of the S+ channel amplifier 412, for producing an S− channel signal for driving the S− channel speaker 408.

FIG. 20 is a diagram illustrating a system 500 including a mobile device 502 reproducing differentially encoded M-S encoded sound on a separate accessory device 504 connected over a wired link 505. The mobile device 502 includes the differential DAC 102, and can be any suitable mobile device for reproducing sound, such as a computer, gaming device, radio, cellular phone, personal digital assistant (PDA), or the like. The mobile device 502 is configured to include the digital domain audio processing, as described above in connection with FIGS. 5, 6, 8 and 9, for producing M-S encoded analog audio signals, and the differential DAC 102.

The accessory device 504 can be any suitable electronic device that is not part of the mobile device's enclosure. For example, the accessory device 504 can be a headset or a separate speaker enclosure. Essentially, the accessory device 504 includes the analog audio processing circuitry for reproducing the M-S channels. The accessory device 504 receives the differential M channel and S+ channel analog audio outputs from the DAC 102 by way of the wired link 505. The accessory device 504 includes the differential M channel audio amplifier 104 for driving the M channel speaker 14, the differential S+ channel audio amplifier 106 for driving an S+ channel speaker 16, and the differential S− channel audio amplifier 108, responsive to the output of the S+channel output of the DAC 102, for producing an S− channel signal for driving the S-channel speaker 82. The polarity of the differential S+ channel signals are reversed as inputs to the S− channel differential amplifier 108 to effectively invert the S+ channel signal, whereby creating the S− channel audio.

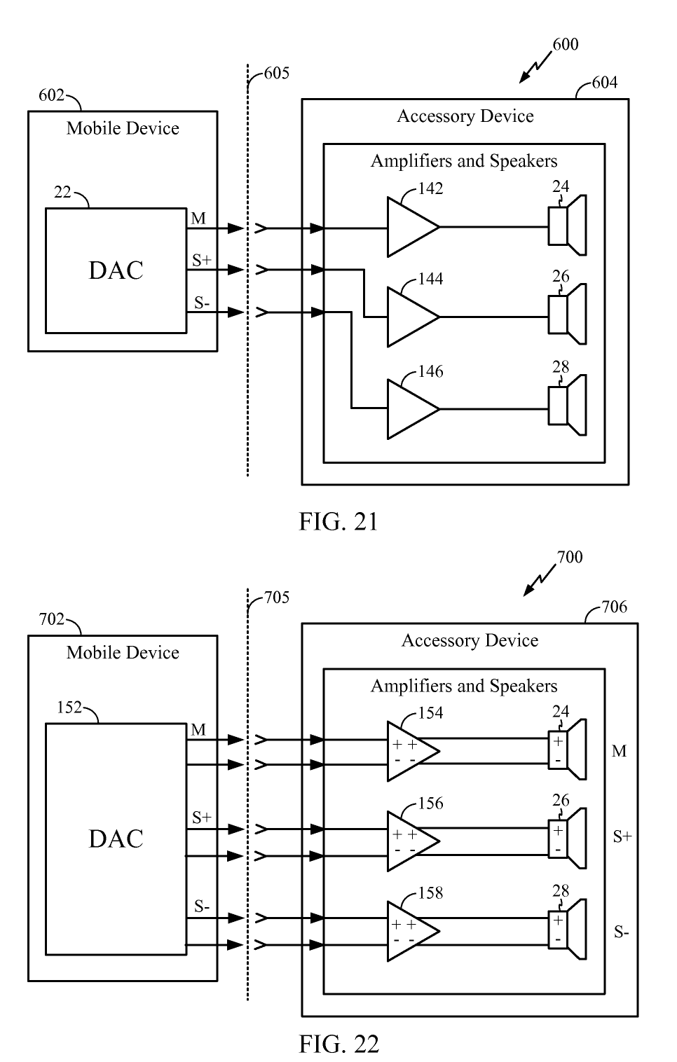

FIG. 21 is a diagram illustrating a system 600 including a mobile device 602 outputting M, S+, S− signals to reproduce M-S encoded sound on a separate accessory device 604 connected over a wired link 605. The mobile device 602 includes the DAC 22, and can be any suitable mobile device for reproducing sound, such as a computer, gaming device, radio, cellular phone, personal digital assistant (PDA), or the like. The mobile device 602 is configured to include the digital domain audio processing and the DAC 22, as described above in connection with FIGS. 12-14, for producing M-S encoded analog audio signals.

The accessory device 604 can be any suitable electronic device that is not part of the mobile device's enclosure. For example, the accessory device 604 can be a headset or a separate speaker enclosure. Essentially, the accessory device 604 includes the analog audio processing circuitry for reproducing the M-S channels. The accessory device 604 receives the M channel, S+ and S− channel analog audio outputs from the DAC 22 by way of the wired link 605. The accessory device 604 includes the M channel audio amplifier 142 for driving the M channel speaker 24, the S+ channel audio amplifier 144 for driving the S+ channel speaker 26, and the S− channel audio amplifier 146 for driving the S− channel speaker 28.

FIG. 22 is a diagram illustrating a system 700 including a mobile device 702 outputting M, S+, S− differential signals to reproduce M-S encoded sound on a separate accessory device 706 connected over a wired link 705. The mobile device 702 includes the differential DAC 152, and can be any suitable mobile device for reproducing sound, such as a computer, gaming device, radio, cellular phone, personal digital assistant (PDA), or the like. The mobile device 702 is configured to include the digital domain audio processing, as described above in connection with FIGS. 12-14, for producing M-S encoded analog audio signals, and the differential DAC 152.

The accessory device 704 can be any suitable electronic device that is not part of the mobile device's enclosure. For example, the accessory device 704 can be a headset or a separate speaker enclosure. Essentially, the accessory device 704 includes at least some of the analog audio processing circuitry for reproducing the M-S channels. The accessory device 704 receives the differential M channel, S+ channel and S-channel analog audio outputs from the DAC 152 by way of the wired link 705. The accessory device 704 includes the differential M channel audio amplifier 154 for driving the M channel speaker 24, the differential S+ channel audio amplifier 156 for driving an S+ channel speaker 26, and the differential S− channel audio amplifier 158 for driving the S− channel speaker 28.

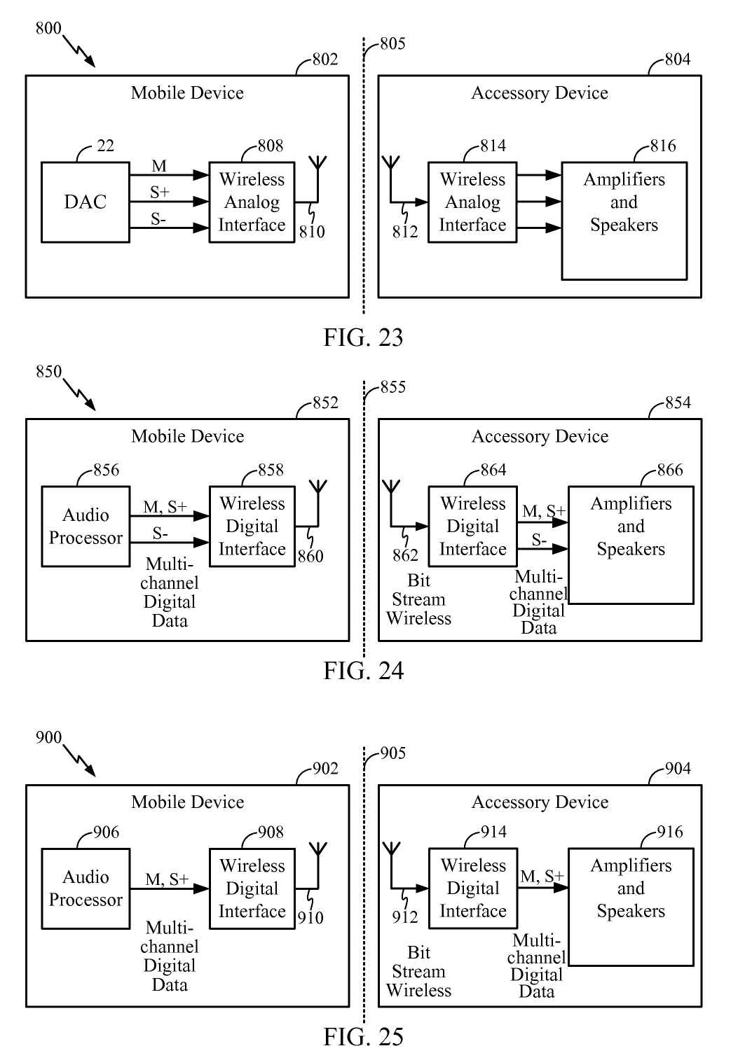

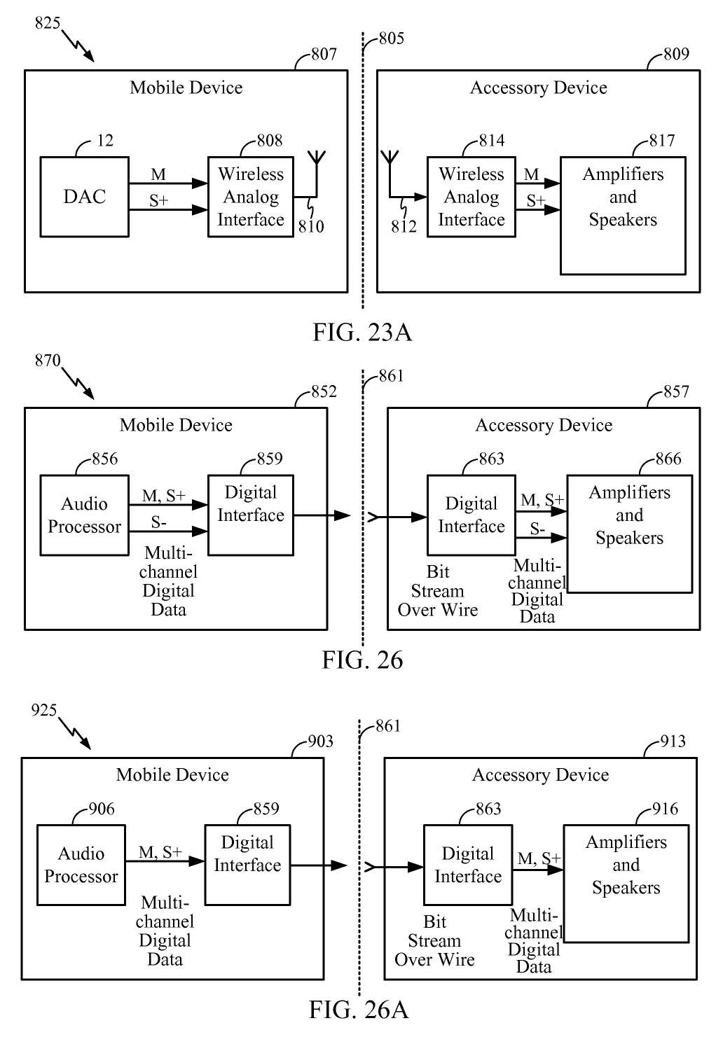

FIG. 23 is a diagram illustrating a system 800 including a mobile device 802 outputting M, S+, S− signals on an analog wireless link 805 to reproduce M-S encoded sound on a separate accessory device 804. The mobile device 802 includes the DAC 22, and can be any suitable mobile device for reproducing sound, such as a computer, gaming device, radio, cellular phone, personal digital assistant (PDA), or the like. The mobile device 802 is configured to include the digital domain audio processing and the DAC 22, as described above in connection with FIGS. 12-14, for producing M-S encoded analog audio signals. In addition to this, the mobile device 802 includes a wireless analog interface 808 and antenna 810 for transmitting the M, S+ and S− analog channels over the wireless link 805 to the accessory device 804.

The accessory device 804 can be any suitable electronic device that is not part of the mobile device's enclosure. For example, the accessory device 804 can be a headset or a separate speaker enclosure. Essentially, the accessory device 804 includes at least some of the analog audio processing circuitry for reproducing the M-S channels from the mobile device 802. The accessory device 804 includes a wireless analog interface 814 and antenna 812 for receiving the M, S+ and S− analog channels from the mobile device 802. The wireless interface 814 provides the M-S channels to amplifiers and speakers 816 included in the accessory device 804 for reproducing the M-S encoded stereo. The amplifiers and speakers 816 can include those components shown and described for the amplifiers and speakers of FIGS. 15 and 21 herein.

FIG. 23A is a diagram illustrating a system 825 including a mobile device 807 outputting only M, S+ signals on an analog wireless link 805 to reproduce M-S encoded sound on a separate accessory device 809. The mobile device 802 may include the DAC 12, and can be any suitable mobile device for reproducing sound, such as a computer, gaming device, radio, cellular phone, personal digital assistant (PDA), or the like. The mobile device 807 is configured to include the digital domain audio processing and the DAC 12, as described above in connection with FIGS. 6 and 8, for producing M-S encoded analog audio signals. In addition to this, the mobile device 802 includes a wireless analog interface 808 and antenna 810 for transmitting the M, S+analog channels over the wireless link 805 to the accessory device 809.

The accessory device 809 can be any suitable electronic device that is not part of the mobile device's enclosure. For example, the accessory device 809 can be a headset or a separate speaker enclosure. Essentially, the accessory device 809 includes at least some of the analog audio processing circuitry for reproducing the M-S channels from the mobile device 807. The accessory device 809 includes a wireless analog interface 814 and antenna 812 for receiving the M, S+ analog channels from the mobile device 802. The wireless interface 814 provides the M-S channels to amplifiers and speakers 817 included in the accessory device 809 for reproducing the M-S encoded stereo. The amplifiers and speakers 817 can include those components shown and described for the amplifiers and speakers of FIGS. 10 and 19 herein.

FIG. 24 is a diagram illustrating a system 850 including a mobile device 852 outputting M, S+, S− signals on a digital wireless link 855 to reproduce M-S encoded sound on a separate accessory device 854. The mobile device 852 includes the digital domain audio processing for M-S conversion, described in connection with FIGS. 13-14 herein, and can be any suitable mobile device for reproducing sound, such as a computer, gaming device, radio, cellular phone, personal digital assistant (PDA), or the like. In addition to this, the mobile device 852 includes a wireless digital interface 858 and antenna 860 for transmitting the M, S+ and S− digital channels over the wireless link 855 to the accessory device 854.

The digital wireless link 855 can be implemented using any suitable wireless protocol and components, such Bluetooth or Wi-Fi. A suitable digital data format for carrying the M, S+ and S− digital audio as data over the digital wireless link 855 is SPDIF or HDMI.

The accessory device 854 can be any suitable electronic device that is not part of the mobile device's enclosure. For example, the accessory device 854 can be a headset or a separate speaker enclosure. Essentially, the accessory device 854 includes a DAC and the analog audio processing circuitry for reproducing the M-S channels received from the mobile device 852. The accessory device 854 includes a wireless digital interface 864 and antenna 862 for receiving the M, S+ and S− digital channels from the mobile device 852. The wireless digital interface 864 provides the M-S channels to the DAC, amplifiers and speakers 866 included in the accessory device 854 for reproducing the M-S encoded stereo. The DAC can be any of the three-channel DACs 22, 152 described herein, and the amplifiers and speakers can include those components shown and described for the amplifiers and speakers of FIGS. 15, 16 and 21 herein.

FIG. 25 is a diagram illustrating a system 900 including a mobile device 902 outputting only M, S+ signals on a wireless link 905 to reproduce M-S encoded sound on a separate accessory device 904. The mobile device 902 includes the digital domain audio processing for M-S conversion, described in connection with FIGS. 6 and 8 herein, and can be any suitable mobile device for reproducing sound, such as a computer, gaming device, radio, cellular phone, personal digital assistant (PDA), or the like. In addition to this, the mobile device 902 includes a wireless digital interface 908 and antenna 910 for transmitting the M, S+ digital channels over the wireless link 905 to the accessory device 904.

The digital wireless link 905 can be implemented using any suitable wireless protocol and components, such Bluetooth or Wi-Fi. A suitable digital data format for carrying the M, S+ and S− digital audio as data over the digital wireless link 905 is SPDIF or HDMI.

The accessory device 904 can be any suitable electronic device that is not part of the mobile device's enclosure. For example, the accessory device 904 can be a headset or a separate speaker enclosure. Essentially, the accessory device 904 includes a DAC and the analog audio processing circuitry for reproducing the M-S channels received from the mobile device 902. The accessory device 904 includes a wireless digital interface 914 and antenna 912 for receiving the M, S+ digital channels from the mobile device 902. The wireless interface 914 provides the M-S channels to the DAC, amplifiers and speakers 916 included in the accessory device 904 for reproducing the M-S encoded stereo. The DAC can be any of the two-channel DACs 12, 102 described herein, and the amplifiers and speakers can include those components shown and described for the amplifiers and speakers of FIGS. 10 and 11 herein.

FIG. 26 is a diagram illustrating a system 870 including a mobile device 853 outputting M, S+, S− signals on a digital wired link 861 to reproduce M-S encoded sound on a separate accessory device 857. The mobile device 853 includes the digital domain audio processing for M-S conversion, described in connection with FIGS. 13-14 herein, and can be any suitable mobile device for reproducing sound, such as a computer, gaming device, radio, cellular phone, personal digital assistant (PDA), or the like. In addition to this, the mobile device 853 includes a digital interface 859 for transmitting the M, S+ and S− digital channels over the wired link 861 to the accessory device 857.

The digital wired link 861 can be implemented using any suitable digital data format such as SPDIF or HDMI for carrying the M, S+ and S− digital audio as data over the digital wired link 861.

The accessory device 857 can be any suitable electronic device that is not part of the mobile device's enclosure. For example, the accessory device 857 can be a headset or a separate speaker enclosure. Essentially, the accessory device 857 includes a DAC and the analog audio processing circuitry for reproducing the M-S channels received from the mobile device 853. The accessory device 857 includes a digital interface 863 for receiving the M, S+ and S− digital channels from the mobile device 853. The digital interface 863 provides the M-S channels to the DAC, amplifiers and speakers 866 included in the accessory device 857 for reproducing the M-S encoded stereo. The DAC can be any of the three-channel DACs 22, 152 described herein, and the amplifiers and speakers can include those components shown and described for the amplifiers and speakers of FIGS. 15, 16 and 21 herein.

FIG. 26A is a diagram illustrating a system 925 including a mobile device 903 outputting only M, S+ signals on a wired link 861 to reproduce M-S encoded sound on a separate accessory device 913. The mobile device 903 may include the digital domain audio processing for M-S conversion, described in connection with FIGS. 6 and 8 herein, and can be any suitable mobile device for reproducing sound, such as a computer, gaming device, radio, cellular phone, personal digital assistant (PDA), or the like. In addition to this, the mobile device 903 includes a digital interface 859 for transmitting the M, S+ digital channels over the wired link 861 to the accessory device 913.

The digital wired link 861 can be implemented using any suitable digital data format such as SPDIF or HDMI for carrying the M, S+ and digital audio as data over the digital wired link 861.

The accessory device 913 can be any suitable electronic device that is not part of the mobile device's enclosure. For example, the accessory device 913 can be a headset or a separate speaker enclosure. Essentially, the accessory device 913 includes a DAC and the analog audio processing circuitry for reproducing the M-S channels received from the mobile device 903. The accessory device 913 includes a digital interface 863 for receiving the M, S+ digital channels from the mobile device 903. The digital interface 863 provides the M-S channels to the DAC, amplifiers and speakers 916 included in the accessory device 913 for reproducing the M-S encoded stereo. The DAC can be any of the two-channel DACs 12, 102 described herein, and the amplifiers and speakers can include those components shown and described for the amplifiers and speakers of FIGS. 10 and 11 herein.

A mobile device or accessory device can be configured to include any suitable combination of the interfaces and communication schemes between mobile devices and accessory devices described above in connection with FIGS. 19-26A.

The functionality of the systems, devices, accessories, apparatuses and their respective components, as well as the method steps and blocks described herein may be implemented in hardware, software, firmware, or any suitable combination thereof. The software/firmware may be a program having sets of instructions (e.g., code segments) executable by one or more digital circuits, such as microprocessors, DSPs, embedded controllers, or intellectual property (IP) cores. If implemented in software/firmware, the functions may be stored on or transmitted over as instructions or code on one or more computer-readable media. Computer-readable medium includes both computer storage medium and communication medium, including any medium that facilitates transfer of a computer program from one place to another. A storage medium may be any available medium that can be accessed by a computer. By way of example, and not limitation, such computer-readable medium can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable medium.

Certain embodiments have been described. However, various modifications to these embodiments are possible, and the principles presented herein may be applied to other embodiments as well. For example, the principles disclosed herein may be applied to devices other than those specifically described herein. In addition, the various components and/or method steps/blocks may be implemented in arrangements other than those specifically disclosed without departing from the scope of the claims.

Other embodiments and modifications will occur readily to those of ordinary skill in the art in view of these teachings. Therefore, the following claims are intended to cover all such embodiments and modifications when viewed in conjunction with the above specification and accompanying drawings.

What is claimed is:

1. A method of outputting mid-side (M-S) encoded sound at a device, comprising:
receiving a digitized mid audio signal at a digital-to-analog converter (DAC) included in the device;
receiving a digitized side audio signal at the DAC;
the DAC converting the digitized mid and side audio signals to analog mid and side audio signals, respectively;
outputting mid channel sound at a first transducer included in the device, in response to the analog mid audio signal; and
outputting side channel sound at a second transducer included in the device, in response to the analog side audio signal.

2. The method of claim 1, further comprising:
inverting the digitized side audio signal to produce a digitized phase-shifted side audio signal;
the DAC converting the digitized phase-shifted side audio signal to an analog phase-shifted side audio signal; and
outputting phase-shifted side channel sound at a third transducer included in the device, in response to the analog phase-shifted side audio signal.

3. The method of claim 2, wherein the digitized phase-shifted side audio signal is shifted by 180 degrees.

4. The method of claim 1, further comprising:
inverting the analog side audio signal to produce an analog phase-shifted side audio signal; and
outputting phase-shifted side channel sound at a third transducer included in the device, in response to the analog phase-shifted side audio signal.

5. The method of claim 4, wherein the analog phase-shifted side audio signal is shifted by 180 degrees.

6. The method of claim 1, further comprising:
adjusting the gain of a signal selected from the group consisting of the digitized mid audio signal, the digitized side audio signal, the analog mid audio signal, the analog side audio signal, and any suitable combination of the foregoing signals.

7. The method of claim 1, wherein the device is a wireless communications handset.

8. The method of claim 7, wherein the first transducer is a handset speaker included in the wireless communications handset and for placing against a user's ear during a call.

9. The method of claim 7, wherein the second transducer is a speakerphone speaker included in the wireless communications handset.

10. An apparatus for reproduction of mid-side (M-S) encoded sound, comprising:
a multi-channel digital-to-analog converter (DAC) having a first channel input receiving a digitized mid audio signal and a first channel output providing an analog mid audio signal in response to the digitized mid audio signal, and a second channel input receiving a digitized side audio signal and a second channel output providing an analog side audio signal in response to the digitized side audio signal.

11. The apparatus of claim 10, further comprising:
a phase inverter to shift the phase of the analog side audio signal.

12. The apparatus of claim 11, wherein the phase inverter shifts the phase of the analog side audio signal by 180 degrees.

13. The apparatus of claim 10, further comprising:
a phase inverter to shift the phase of the digitized side audio signal.

14. The apparatus of claim 13, wherein the phase inverter shifts the phase of the digitized side audio signal by 180 degrees.

15. The apparatus of claim 13, wherein the multi-channel DAC includes a third channel input coupled to the output of the phase inverter and responsive to the phase-shifted digitized side audio signal, and a third channel output providing an phase-sifted analog side audio signal.

16. The apparatus of claim 10, further comprising:
a first transducer configured to produce mid channel sound in response to the analog mid audio signal; and
a second transducer configured to produce side channel audio in response to the analog side signal.

17. The apparatus of claim 16, wherein the first transducer is a handset speaker included in a wireless communications handset and for placing against a user's ear during a call.

18. The apparatus of claim 16, wherein the second transducer is a speakerphone speaker included in a wireless communications handset.

19. The apparatus of claim 16, further comprising:
a third transducer configured to produce phase-shift channel sound in response to an analog phase-shifted side audio signal.

20. The apparatus of claim 10, wherein the apparatus is a wireless communications handset configured to concurrently operate in handset mode and speakerphone mode.

21. The apparatus of claim 10, further comprising a gain circuit to apply a gain factor to the digitized mid audio signal, the analog mid audio signal, the digitized side audio signal or the analog side audio signal.

22. The apparatus of claim 10, further comprising an interface configured to transfer the analog mid and side signals to an accessory device for reproduction at the accessory device.

23. An apparatus for reproduction of mid-side (M-S) encoded sound, comprising:
a first divide-by-two circuit responsive to a digitized left channel stereo audio signal;
a second divide-by-two circuit responsive to a digitized right channel stereo audio signal;
a summer to sum digitized left and right channel stereo audio outputs from the first and second divide-by-two circuits;
a subtractor to determine the difference between the digitized left and right channel stereo audio outputs from the first and second divide-by-two circuits;
a multi-channel digital-to-analog converter (DAC) having a first channel input responsive to digitized sum audio output from the summer and a first channel output providing an analog sum audio signal, and a second channel input responsive to digitized difference audio output from the subtractor and a second channel output providing an analog difference audio signal.
a first speaker to produce mid channel sound in response to the analog sum audio signal; and
a second speaker to produce side channel sound in response to the analog difference signal.

24. The apparatus of claim 23, further comprising:
a phase inverter to invert the phase of the analog difference audio signal.

25. The apparatus of claim 24, further comprising:
a third speaker to produce inverted side channel sound in response to the inverted analog difference audio signal.

26. The apparatus of claim 23, further comprising:
a digital phase inverter to invert the digitized difference audio output.

27. The apparatus of claim 26, wherein the multi-channel DAC includes a third channel input responsive to the inverted digitized difference audio output, and a third channel output providing an inverted analog difference audio signal.

28. The apparatus of claim 27, further comprising:
a third speaker to produce inverted side channel sound in response to the inverted analog difference audio signal.

29. The apparatus of claim 23, wherein the apparatus is a wireless communications handset.

30. The apparatus of claim 29, wherein the wireless communication handset is configured to concurrently operate in handset mode and speakerphone mode.

31. The apparatus of claim 23, wherein the first and second divide-by-two circuits include circuitry configured to increase the bit widths of the digitized left channel and right channel stereo audio signals, and to arithmetically shift the digitized left channel and right channel stereo audio signals to the right.

32. The apparatus of claim 23, further comprising circuitry configured to left-shift and decrease the bit width of the outputs of the summer and the subtractor.

33. An apparatus, comprising:
means for receiving a digitized mid audio signal at a digital-to-analog converter (DAC);
means for receiving a digitized side audio signal at the DAC;
means for converting a digitized mid audio signal to an analog mid audio signal;
means for converting a digitized side audio signal to an analog side audio signal;
means for outputting mid channel sound in response to the analog mid audio signal; and
means for outputting side channel sound in response to the analog side audio signal.

34. The apparatus of claim 33, further comprising:
means for inverting the analog side signal to produce an inverted analog side signal.

35. The apparatus of claim 33, further comprising:
means for inverting the digitized side audio signal to produce an inverted digitized side audio signal.

36. The apparatus of claim 33, further comprising:
means for applying a gain factor to the digitized mid audio signal, the analog mid audio signal, the digitized side audio signal or the analog side audio signal.

37. A computer-readable medium embodying a set of instructions executable by one or more processors, comprising:
code for receiving a digitized mid audio signal at a multi-channel digital-to-analog converter (DAC);
code for receiving a digitized side audio signal at the multi-channel DAC;
code for converting a digitized mid audio signal to an analog mid audio signal;
code for converting a digitized side audio signal to an analog side audio signal;
code for outputting mid channel sound in response to the analog mid audio signal; and
code for outputting side channel sound in response to the analog side audio signal.

38. The computer-readable medium of claim 37, further comprising:
code for inverting the digitized side audio signal to produce an inverted digitized side audio signal.

39. The computer-readable medium of claim 37, further comprising:
code for applying a gain factor to the digitized mid audio signal, the analog mid audio signal, the digitized side audio signal or the analog side audio signal.

40. A system, comprising:
a mobile device configured to produce M-S encoded stereo signals and having an interface for transferring the M-S encoded stereo signals to an accessory device; and
the accessory device including an interface configured to received the M-S encoded stereo signals and means for reproducing the M-S encoded stereo signals.

41. The system of claim 40, wherein the interface of the mobile device is selected from the group consisting of a wireless analog interface, a wireless digital interface, a analog interface for a wired link, a digital interface for a wired link and any suitable combination of the foregoing.

42. The system of claim 40, wherein the interface of the accessory device is selected from the group consisting of a wireless analog interface, a wireless digital interface, a analog interface for a wired link, a digital interface for a wired link and any suitable combination of the foregoing.

43. The system of claim 40, wherein the M-S encoded stereo signals transferred by the mobile device include a mid channel signal and a pair of side channel signals.

44. The system of claim 43, wherein the mid and side channel signals are differential signals.

45. The system of claim 40, wherein the M-S encoded stereo signals transferred by the mobile device include a mid channel signal and only one side channel signal.

46. The system of claim 45, wherein the mid and side channel signals are differential signals.
